(19) United States
(12) Patent Application Publication
(10) Pub. No.: US 2010/0083342 A1
(43) Pub. Date: Apr. 1, 2010

(54) AUDIO/VIDEO TRANSMISSION DEVICE

(76) Inventor: Tsai-Yun CHEN, Hsin Chu City (TW)

Correspondence Address: Muncy, Geissler, Olds & Lowe, PLLC, P.O. BOX 1364, FAIRFAX, VA, 22038-1364, US

(21) Appl. No.: 12/243,242

(22) Filed: Oct. 1, 2008

(51) Int. Cl. H04N 7/16

(52) U.S. Cl. 725/149

(57) ABSTRACT

An AV transmission device includes a network cable and two transmission terminals. The network cable has eight transmission lines, which are grouped into four transmission line pairs. The two transmission terminals are respectively connected to one of two ends of the network cable. With the AV transmission device, power supply and a video signal can be coupled with each other and then transmitted via one of the four transmission line pairs. A control signal and left and right channel signals are respectively transmitted via one of the rest three transmission line pairs. Thus, when expanding an AV transmission range, it is not necessary to provide additional power supply at a remote location, signal transmission cost can be reduced, and a remote AV system can be conveniently operated locally.

### FIELD OF THE INVENTION

The present invention relates to an audio/video (AV) transmission device, and more particularly to an AV transmission device allowing expansion of transmission range via a network cable.

### BACKGROUND OF THE INVENTION

With the upgraded living quality in the modern society, almost every home owns one or more audio and video (AV) apparatus, such as DVD player, LCD TV, stereo, etc. Usually, an AV apparatus is individually mounted in one room and could not be controlled from another room or a different area due to restriction in the transmission range of a control signal and/or the length of an AV transmission cable.

Therefore, it is desirable to develop an AV transmission device that allows a user to expand an original AV signal transmission range without the need of adding power supply at a remote location, so that cost of signal transmission can be reduced, and a remote AV system can be conveniently controlled and operated locally.

### SUMMARY OF THE INVENTION

In view of the foregoing shortcomings of the prior art, the inventor of the present invention has based on years of experience in the related field to conduct extensive researches and experiments, and finally invented an audio/video transmission device to overcome the shortcomings of the prior art.

A primary object of the present invention is to provide an AV transmission device, which can be connected to existing widely installed network cables to transmit electrical power, AV signals, and control signals, enabling a user to expand an original AV transmission range without the need of adding power supply at a remote location. Thus, cost of signal transmission can be reduced, and a remote AV system can be locally controlled and operated.

To achieve the above and other objects, the AV transmission device according to the present invention includes a network cable and two transmission terminals. The network cable has eight transmission lines, which are grouped into four transmission line pairs. The two transmission terminals are respectively connected to one of two ends of the network cable. A video signal coupled with electrical power, a control signal, a left channel signal, and a right channel signal can be input to one of the two transmission terminals and then respectively transmitted via one of the four transmission line pairs to be output at the other transmission terminal.

The AV transmission device of the present invention further includes at least one processing unit provided in one or both of the two transmission terminals. With the processing unit, electrical power and video signal can be coupled with each other without mutual interference, and the electrical power can be used to drive transmission of the control signal or be supplied to a remote AV system. The processing unit includes a processing circuit, with which the power supply and the video signal can be coupled with each other without mutual interference, and the electrical power can be used to drive transmission of the control signal or be supplied to a remote AV system.

Therefore, with the above arrangements, a user can expand an original AV transmission range without the need of adding power supply at a remote location, cost of signal transmission can be reduced, and a remote AV system can be conveniently controlled and operated locally.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an AV transmission device according to a preferred embodiment of the present invention; and

FIG. 2 is a conceptual view of the AV transmission device according to the preferred embodiment of the present invention.

### DETAILED DESCRIPTION OF THE PREFERRED EMBODIMENTS

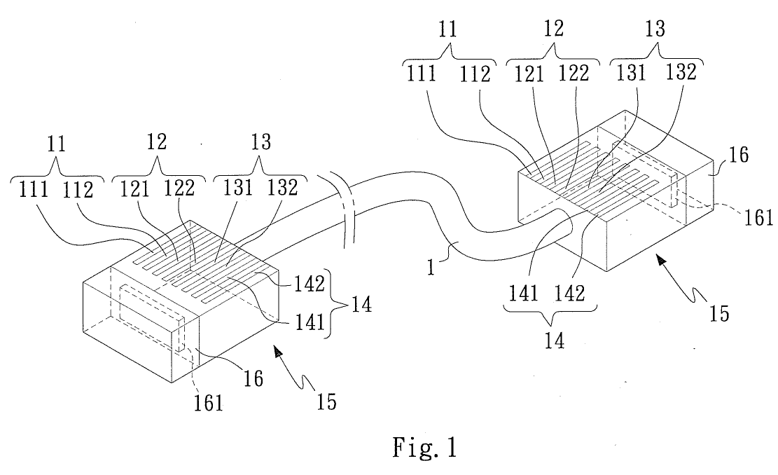

Please refer to FIG. 1 that is a perspective view of an AV transmission device according to a preferred embodiment of the present invention. As shown, the AV transmission device includes a network cable 1 and two transmission terminals 15 being respectively connected to one of two ends of the network cable 1. The network cable 1 has eight transmission lines 111, 112, 121, 122, 131, 132, 141, 142. The transmission lines 111, 112 are grouped to form a first transmission line pair 11, the transmission lines 121, 122 are grouped to form a second transmission line pair 12, the transmission lines 131, 132 are grouped to form a third transmission line pair 13, and the transmission lines 141, 142 are grouped to form a fourth transmission line pair 14. The AV transmission device of the present invention allows a video signal coupled with electrical power, a control signal, a left channel signal, and a right channel signal to be input to one of the two transmission terminals 15, and then transmitted via the first, the second, the third, and the fourth transmission line pair 11, 12, 13, 14, respectively, to be output at the other transmission terminal 15. However, the four different signals can be respectively transmitted via any one of the four transmission line pairs 11, 12, 13, 14 without being limited to the above-mentioned transmission manner. Further, when assembling the AV transmission device to an AV system, a user may use any one of the two transmission terminals as an input terminal or an output terminal.

The AV transmission device of the present invention further includes at least one processing unit 16 provided in one or both of the two transmission terminals 15. With the processing unit 16, the electrical power and the video signal can be coupled with each other without mutual interference between them, and then be stably transmitted via one of the four transmission line pairs. The electrical power can be used to drive the transmission of the control signal, or be supplied to a remote AV system. The processing unit 16 has a processing circuit 161, with which the electrical power and the video signal are coupled with each other without mutual interference between them, and the electrical power can be used to drive the transmission of the control signal or be supplied to a remote AV system.

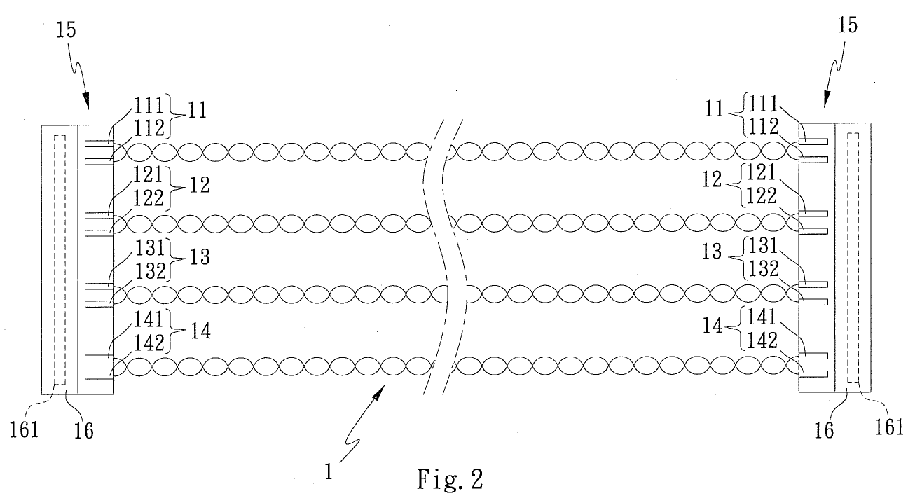

FIG. 2 is a conceptual view of the AV transmission device according to the preferred embodiment of the present invention. As shown, to use the AV transmission device of the present invention, one of the two transmission terminals 15 connected to two ends of the network cable 1 can be set to an input terminal while the other an output terminal. In the illustrated embodiment, the transmission terminal 15 located at the left side of the drawing is used as the input terminal and the other transmission terminal 15 located at the right side of the drawing is used as the output terminal. A user can input the video signal coupled with electrical power, the control signal, the left channel signal, and the right channel signal via the transmission terminal 15 serving as the input terminal. Then, these signals are respectively transmitted via the transmission lines 111, 112 of the first transmission line pair 11, the transmission lines 121, 122 of the second transmission line pair 12, the transmission lines 131, 132 of the third transmission line pair 13, and the transmission lines 141, 142 of the fourth transmission line pairs 14 to the other transmission terminal 15 serving as the output terminal. Due to processing by the processing circuit 161 of the processing unit 16, the electrical power and the video signal are coupled with each other without mutual interference. And, the electrical power can be used to drive the transmission of the control signal or be supplied to a remote AV system. Since network cables have been widely installed in general residential houses, communities, urban or even rural areas, the AV transmission device of the present invention can be conveniently used with the existing network cables to transmit electrical power, AV signals, and control signals to remote locations without the need of laying and installing a large quantity of signal transmission cables to thereby save a lot of cost of signal transmission.

With the above arrangements, the AV transmission device of the present invention is novel, improved, and industrially practical for use. Since the present invention can utilize the existing widely installed network cables to transmit electrical power, AV signals, and control signals, when it is desired to expand an original AV transmission range, it is not necessary to add power supply at a remote location. Thus, cost of signal transmission is reduced, and a remote AV system can be locally controlled and operated. Therefore, products derived from the present invention would no doubt fulfill the market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An AV transmission device, comprising:
a network cable having eight transmission lines, and the eight transmission lines being grouped into four transmission line pairs; and
two transmission terminals being respectively connected to one of two ends of the network cable;
wherein a video signal coupled with electrical power, a control signal, a left channel signal, and a right channel signal are input to one of the two transmission terminals serving as an input terminal, and then transmitted via the four transmission line pairs to be output at the other transmission terminal serving as an output terminal.

2. The AV transmission device as claimed in claim 1, further comprising at least one processing unit being provided in one or both of the two transmission terminals; whereby, with the processing unit, electrical power and the video signal can be coupled with each other without mutual interference between them, and the electrical power can be used to drive transmission of the control signal or be supplied to a remote AV system.

3. The AV transmission device as claimed in claim 2, wherein the processing unit includes a processing circuit, and, with the processing circuit, the electrical power and the video signal can be coupled with each other without mutual interference, and the electrical power can be used to drive transmission of the control signal or be supplied to a remote AV system.
